(19) United States
(12) Patent Application Publication
(10) Pub. No.: US 2010/0277268 A1
(43) Pub. Date: Nov. 4, 2010

(54) THERMAL SAFETY DEVICE

(76) Inventor: Peter Ireman, Ver Sur Mer (FR)

Correspondence Address: BROWDY AND NEIMARK, P.L.L.C.;624 NINTH STREET, NW, SUITE 300, WASHINGTON, DC, 20001-5303, US

(21) Appl. No.: 12/812,328

(22) PCT Filed: Jan. 6, 2009
(86) PCT No.: PCT/FR09/00004

§ 371 Date: Jul. 9, 2010

(30) Foreign Application Priority Data
Jan. 10, 2008 (FR) 08 00136

(51) Int. Cl. H01H 37/76

(52) U.S. Cl. 337/402

(57) ABSTRACT

The invention relates to a thermal safety device intended to be fixed to a substrate (2), comprising a strip fuse (20) comprising a metal strip provided with a first contact zone (23) electrically connected to a first pad (8) on the substrate (2) and also provided with at least one other contact zone (22) capable of being soldered to another pad (7) on the substrate (2), said strip fuse (20) also comprising a lever (30) having a free end (36) not connected to the metal strip (21). According to the invention, the lever (30) generates a tilting moment of the soldered contact zone (22) about at least one pivot point disposed between the two contact zones (22, 23) when the end (36) of the lever (30) is pressed.

The present invention relates to a thermal safety device for a heating element deposited on a substrate, forming a heating subassembly particularly included in a household electrical appliance.

There is a temperature-sensitive cutout known from the document EP 0654170, intended to be fixed to a substrate, comprising a leaf spring provided at each of its ends with a contact soldered to a corresponding contact pad on the substrate. Between the two soldered contacts, the leaf spring comprises an arm composed of a roof-shaped part followed by a flat section. The cutout is activated by applying pressure on the roof, which generates a bending of the flat section and a lifting moment of the contact disposed next to the section. When the substrate overheats, the solder of the contact melts and the lifting moment produces a lateral displacement of the contact, which opens the circuit. However, the opening of the contact is generated by a slight deformation of the roof, thus requiring very precise control of the dimensions of the spring and of the various parts exerting pressure on the roof. Moreover, this type of cutout requires a considerable amount of space between the contacts in order to accommodate the roof-shaped part and the flat section.

There is another thermal safety device known from the document WO 98/20510, comprising a metal strip soldered to a substrate between two contact pads. The strip has a cantilevered end which is mechanically stressed by a wall of a housing. When there is overheating in the vicinity of the contact pads, the solder joints melt and the stress exerted on the end of the strip causes the circuit to open by separating the contact located on the end opposite the cantilevered end. However, this thermal safety device only works if the two solders of the pads melt simultaneously, which requires the same thermal environment for each pad. Moreover, the metal strip provided with a cantilevered end is long and thus difficult to install in a small space.

The object of the present invention is to eliminate the aforementioned drawbacks and to propose a thermal safety device that offers high reliability and safe operation.

Another object of the invention is to propose a thermal safety device that is simple and economical to use.

Another object of the invention is to propose a thermal safety device that is compact so that it can be installed in a small space.

These objects are achieved with a thermal safety device intended to be fixed to a substrate, comprising a strip fuse comprising a metal strip provided with a first contact zone electrically connected to a first pad on the substrate and also provided with at least one other contact zone capable of being soldered to another pad on the substrate, the strip fuse also comprising a lever having a free end not connected to the metal strip, characterized in that the lever generates a tilting moment of the soldered contact zone about at least one pivot point disposed between the two contact zones when the end of the lever is pressed.

The thermal safety device thus produced comprises a strip fuse whose shape is stable when it is soldered to the substrate, and the device is subsequently activated by pressing on the end of the lever. According to the invention, the pivot point around which the tilting moment is generated by the lever is disposed between the two contact zones, thus enabling the device to have a compact structure.

Advantageously, the pressure on the end of the lever occurs outside the two contact zones.

This feature makes it possible to obtain a lever arm long enough to guarantee, when the device overheats, a displacement of the contact zone relative to the pad with an even greater margin of safety in terms of electrical isolation.

Preferably, the lever has two arms disposed alongside the metal strip.

This feature makes it possible to balance the forces generating the tilting moment of the soldered contact zone.

Advantageously, each arm of the lever has stiffening means.

This feature makes it possible to keep the arms of the lever from bending in order to transmit the tilting moment to the soldered contact zone.

Preferably the stiffening means of each arm of the lever are formed by a longitudinal bend.

This feature makes it possible to stiffen the lever arms simply and economically without adding any parts.

Advantageously, the metal strip has at least two bends located between the pivot point and the first contact zone.

This feature makes it possible to create additional pivot points which increase the opening of the contact zone.

Preferably, the metal strip and the lever are formed in the same strip of metal.

This feature makes it possible to produce the strip fuse of the thermal safety device simply and economically.

Advantageously, at least the soldered contact zone is reflow soldered.

This feature makes it possible to attach all of the components that must be soldered to the substrate of the type electronic components, connection elements . . . in a single production phase.

The invention will be more clearly understood by studying the embodiment taken as a nonlimiting example and illustrated in the attached figures, in which:

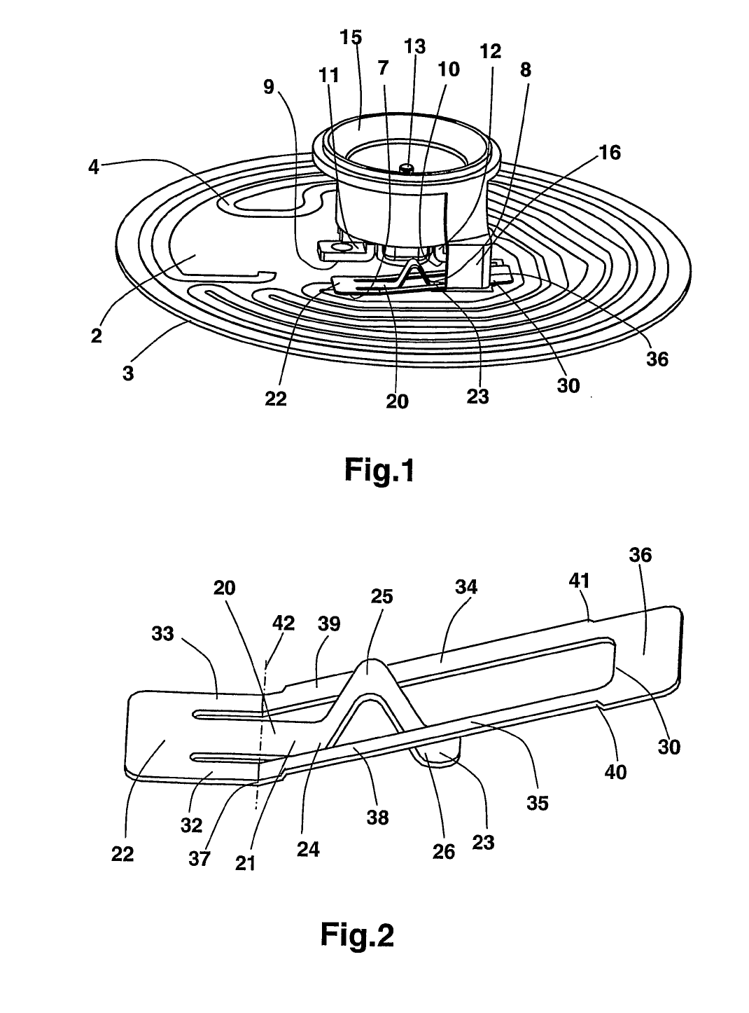

FIG. 1 illustrates a perspective view of a thermal safety device activated according to a particular embodiment of the invention.

FIG. 2 illustrates a perspective view of a strip fuse of the thermal safety device of FIG. 1.

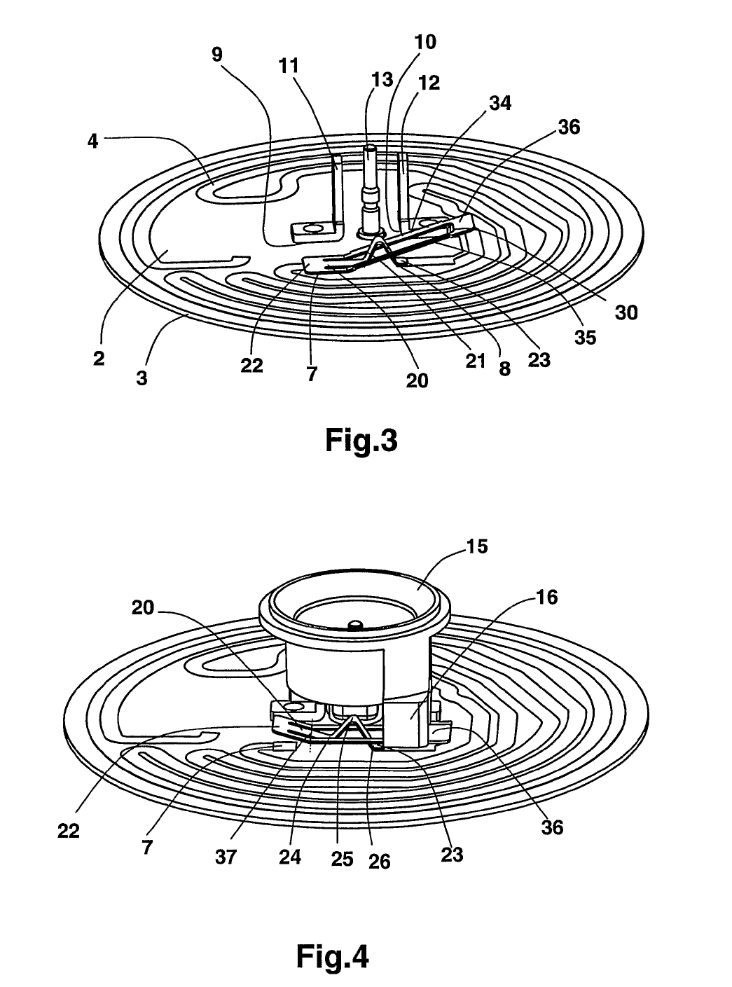

FIG. 3 illustrates a perspective view of the thermal safety device of FIG. 1 wherein the strip fuse is soldered to a substrate before the lever is pressed.

FIG. 4 illustrates a perspective view of the thermal safety device of FIG. 1 after the soldered contact has melted.

As seen in FIG. 1, the thermal safety device is incorporated into a heating base for a liquid-heating appliance. The thermal safety device comprises a strip fuse 20 fixed to a substrate 2 comprising a metal disk 3 made of stainless steel equipped with a serigraphed heating resistor 4 held between two insulating enamel layers. The external enamel layer has holes into which contact pads are deposited. The heating base includes the female part of a detachable connector composed of two power pins 11, 12 soldered to the two contact pads 9, 10, a ground pin 13 connected directly to the metal disk 3, and a plastic cover 15 which covers the three pins 11, 12, 13. The heating base also includes means for controlling the heating of the resistor, not shown in the figure.

The heating resistor 4 has an end provided with a hot point 7 which, as the appliance heats up, stays relatively hot due to the pattern of the track of the heating resistor 4. The power pin 12 is connected to a track having an end provided with a cold point 8, which stays relatively cold as the appliance heats up.

As seen in FIG. 2, the strip fuse 20 comprises a metal strip 21 comprising two ends, each equipped with a contact zone 22, 23, respectively soldered to the hot point 7 and to the cold point 8. The strip fuse 20 thus electrically connects the heating resistor 4 to the power pin 12.

The strip fuse 20 also includes a lever 30 comprising two arms 34 35, disposed alongside the metal strip 21 and integral with the latter at the level of the contact zone 22 soldered to the hot point 7. The two arms 34, 35 of the lever 30 each include a first part 32, 33 parallel to the metal strip 21 and a second, inclined part 38, 39. The inclined parts 38, 39 join to form an end 36, which serves as a pressing zone. The junction between the first part 32, 33 and the second, inclined part 38, 39 defines a pivot point 37 about a transverse axis 42.

The metal strip 21 comprises, between the pivot point 37 and the contact zone 23 soldered to the cold point 8, three successive bends 24, 25, 26 forming an inverted V.

Each arm 34, 35 of the lever 30 comprises, in its inclined part 38, 39, an outer edge provided with a reinforcing longitudinal bend 40, 41.

As seen in FIG. 3, the strip fuse 20 has a stable shape in order to enable it to be soldered to the substrate without any particular means of support.

All the solders of the power pins 11, 12 and the contact zones 22, 23 of the strip fuse 20 are reflow soldered in the same production operation.

After soldering, the plastic cover 15 of the connector (FIG. 1) is mounted on the power pins 11, 12 and on the ground pin 13. The cover has a lateral protuberance 16 which causes the arms 34, 35 of the lever 40 to pivot by pressing on the end 36 during the vertical mounting movement. This movement of the arms 34, 35 generates a tilting moment of the contact zone 22 soldered to the hot point 7 about the pivot point 37. Once the plastic cover 15 of the connector is mounted in place, the thermal safety device is activated.

In operation, in the event of a failure of the means for controlling the heating of the heating resistor 4, the temperature around the hot point 7 reaches the melting temperature of the solder (FIG. 4). The moment generated by the arms 34, 35 of the lever 30 causes the contact zone 22 to tilt, primarily about the pivot point 37, although this pivot point 37 can itself pivot about the three bends 24, 25, 26 in the metal strip 21 so as to allow a displacement of the contact zone 22 relative to the hot point 7 of more than three millimeters, thus disconnecting the power supply circuit of the heating resistor 4 and guaranteeing electrical isolation. The heating resistor 4 is positioned on the substrate 2 in such a way that the other solders do not melt, particularly that of the cold point 8, which holds the strip fuse 20 in place even after the melting of the solder at the level of the hot point 7.

It is understood that the invention is not in any way limited to the embodiment described and illustrated, which has been given only as an example. Modifications are possible, particularly in terms of the composition of the various elements or the substitution of technical equivalents, without going outside the scope of protection of the invention.

Thus, the metal strip of the strip fuse may not include bends and may not be rectilinear.

In a variant of embodiment, the lever arm may be connected to the metal strip by a connecting means of the soldering or crimping type.

In another variant of embodiment, the lever may be cut out of the center of the metal strip. In that case, the free end of the lever is located between the pivot point and the contact zone soldered to the cold point.

1. Thermal safety device intended to be fixed to a substrate (2) comprising a strip fuse (20) comprising a metal strip (21) provided with a first contact zone (23) electrically connected to a first contact pad (8) on the substrate (2) and also provided with at least one other contact zone (22) capable of being soldered to another pad (7) on the substrate (2), said strip fuse (20) also comprising a lever (30) having a free end (36) not connected to the metal strip (21), characterized in that the lever (30) generates a tilting moment of the soldered contact zone (22) about at least one pivot point (37) disposed between the two contact zones (22, 23) when the end (36) of the lever (30) is pressed.

2. Thermal safety device according to claim 1, characterized in that the pressure on the end (36) of the lever (30) occurs outside the two contact zones (22, 23).

3. Thermal safety device according to claim 2, characterized in that the lever (30) has two arms (34, 35) disposed alongside the metal strip (21).

4. Thermal safety device according to claim 3, characterized in that each arm (34, 35) of the lever (30) has stiffening means (40, 41).

5. Thermal safety device according to claim 4, characterized in that the stiffening means of each arm (34, 35) of the lever (30) are formed by a longitudinal bend (40, 41).

6. Thermal safety device according to claim 5, characterized in that the metal strip (21) has at least two bends (24, 25, 26) located between the pivot point (37) and the first contact zone (23).

7. Thermal safety device according to claim 6, characterized in that the metal strip (21) and the lever (3) are formed in the same strip of metal.

8. Thermal safety device according to claim 7, characterized in that at least the soldered contact zone (22) is reflow soldered.

9. Thermal safety device according to claim 1, characterized in that the lever (30) has two arms (34, 35) disposed alongside the metal strip (21).

10. Thermal safety device according to claim 9, characterized in that each arm (34, 35) of the lever (30) has stiffening means (40, 41).

11. Thermal safety device according to claim 10, characterized in that the stiffening means of each arm (34, 35) of the lever (30) are formed by a longitudinal bend (40, 41).

12. Thermal safety device according to claim 1, characterized in that the metal strip (21) has at least two bends (24, 25, 26) located between the pivot point (37) and the first contact zone (23).

13. Thermal safety device according to claim 1, characterized in that the metal strip (21) and the lever (3) are formed in the same strip of metal.

14. Thermal safety device according to claim 1, characterized in that at least the soldered contact zone (22) is reflow soldered.
